(19) United States
(12) Patent Application Publication
(10) Pub. No.: US 2006/0261875 A1
(43) Pub. Date: Nov. 23, 2006

(54) Mixer circuit, receiver comprising a mixer circuit method for generating an output signal by mixing an input signal with an oscillator signal

(76) Inventors: Lucien Johannes Breems, Eindhoven (NL); Quino Alexander Sandifort, Nijmegen (NL); Han Martijn Schuurmans, Nijmegen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/571,635

(22) PCT Filed: Aug. 31, 2004
(86) PCT No.: PCT/IB04/51615

§ 371 Date: Mar. 14, 2006

(30) Foreign Application Priority Data
Sep. 16, 2003 (EP) 03103410.1

(51) Int. Cl. G06F 7/44

(52) U.S. Cl. 327/359

(57) ABSTRACT

The invention relates to a mixer circuit, a receiver comprising a mixer circuit, and a method of mixing an input signal with an oscillator signal. A mixer circuit 300 according to the invention comprises a first input node 301 and a second input node 302 for receiving an input signal Vin, a first output node 321 and a second output node 322, voltage to-current conversion means R1a, R1b, R2a, R2b, and switching means M1, M2, M3, M4 operatively coupled to each other and to the first input node 301, the second input 305 node 302, the first output node 321, and the second output node 322 to generate a mixed input signal the first output node 321 and the second output node 322 in response to an oscillator signal. The voltage-to-current conversion means R1a, R1b, R2a, R2b comprises a first voltage-to current converter RI a, R2a for generating a first current at a first Vdac switching node 311 and a third current at a third switching node 313 in response to the input signal Vin, and a second voltage-to-current converter R1b, R2b for generating a second current at a second switching node 312 and a fourth current a fourth switching node 314 in response to the input signal Vin. The switching means M1, M2, M3, M4 is arranged to couple the second switching node 312 to the second output node 322 and the third switching node 313 to the first output node 321 during a first phase φ1 of the oscillator signal; and the first switching node 311 to the first output node 321 and the fourth switching node 314 to the second output node 322 during a second phase φ2 of the oscillator signal. As a result first and third switching nodes 311, 313 are isolated from respectively second and fourth switching node 312, 314. This prevents cross-over distortion from parasitic capacitances associated with first and third switching nodes 311, 313 via respective switches M2 and M4, and vice versa from parasitic capacitances associated with second and fourth switching nodes 312, 314 via respective switches M1 and M3.

The invention relates to a mixer circuit as defined in the preamble of claim 1.

The invention also relates to a receiver as defined in the preamble of claim 9.

The invention also relates to a method for generating an output signal by mixing an input signal with an oscillator signal as defined in the preamble of claim 10.

A mixer circuit as defined in the opening paragraph is generally known. In the known mixer circuit the first input node is connected to a first switching node by means of a first resistor. The second input node is connected to a second switching node by means of a second resistor. The first resistor and the second resistor convert the input signal, a voltage, at the first input node and the second input node into a first current at the first switching node and a second current at the second switching node.

The first switching node is connected to the first output node by means of a switch. The first switching node is connected to the second output node by means of a second switch. The second switching node is connected to the first output node by means of a third switch. The second switching node is connected to the second output node by means of a fourth switch. During a first phase of the oscillator signal the second switch and the second switch and the third switch are conductive, while the first switch and the fourth switch are non-conductive. Thus the first current appears at the second output node and the second current at the first output node. During a second phase of the oscillator signal the first switch and the fourth switch are conductive, while the second switch and the third switch are non-conductive. Thus the first current appears at the first output node and the second current at the second output node. In this way a mixed version of the input signal is generated at the first and second output nodes.

For interfacing with succeeding signal processing circuitry it is usually preferable to have an output voltage instead of a current mode output signal. For this reason a current-to-voltage converter may connected with its input to the first and second output nodes for generating an output voltage at a third and fourth output node in response to the mixed first and second currents generated at the first and second output nodes. Ideally the current-to-voltage converter keeps the first output node and the second output node at the same voltage level. In practice, due to non-idealities in the current-to-voltage converter a residue voltage or voltage difference will be present between the first output node and the second output node. This results in a distortion in the voltage output at the third and fourth output node.

The invention is based on the insight that the distortion in the output voltage at the third and fourth output node is at least partially caused by the mixer circuit. In practice a first parasitic capacitance is present between the first switching node and a reference node, for instance ground, and a second parasitic capacitance is present between the second switching node ant the reference node. During the first phase of the oscillator signal when the second and third switch are conductive this residue voltage is sampled at the first and second parasitic capacitances. During the second phase of the oscillator when the first and fourth switch are conductive the residue voltage during the first phase is cross-coupled to the first and second output nodes. This results in distortion of the mixed first and second currents generated at the first and second output nodes and thereby in a distortion of the output voltage at the third and fourth output nodes.

Amongst others it is therefore an object of the invention to reduce the above mentioned distortion caused by cross-coupling of voltage differences between the first and second output node.

To this end the invention provides a mixer circuit as defined in the opening paragraph which is characterized by the characterizing part of claim 1. In the mixer circuit according to the invention the first switching node is effectively disconnected from the second switching node and the third switching node is effectively disconnected form the fourth switching node. In this way it is prevented that a residue signal sampled at parasitic capacitances associated with the second and third switching nodes during the first phase of the oscillator signal is cross-coupled to the first and fourth switching node during the second phase of the oscillator. Vice-versa it is prevented that a residue signal sampled at parasitic capacitances associated with the first and fourth switching nodes during the second phase of the oscillator signal is cross-coupled to the second and third switching node during the first phase of the oscillator signal.

A receiver as defined in the opening paragraph according to the invention is characterized by the characterizing portion of claim 9. In the mixer circuit of the receiver according to the invention the first switching node is effectively disconnected from the second switching node and the third switching node is effectively disconnected form the fourth switching node. In this way it is prevented that out of band noise is mixed into the signal band by the mixer circuit.

A method for generating an output signal by mixing an input signal with an oscillator signal as defined in the opening paragraph is characterized by the characterizing portion of claim 10. In this way it is prevented that a residue signal sampled at parasitic capacitances associated with the second and third switching nodes during the first phase of the oscillator signal is cross-coupled to the first and fourth switching node during the second phase of the oscillator. Vice-versa it is prevented that a residue signal sampled at parasitic capacitances associated with the first and fourth switching nodes during the second phase of the oscillator signal is cross-coupled to the second and third switching node during the first phase of the oscillator signal.

In a preferred embodiment the first voltage-to-current converter comprises a first resistor coupled between the first input node and the first switching node and a third resistor coupled between the second input node and the third switching node, and the second voltage-to-current converter comprises a second resistor coupled between the first input node and the second switching node and a fourth resistor coupled between the second input node and the fourth switching node. The resistors are simple and practical means for converting voltages into currents. Furthermore by using a separate first and second resistor to couple the first input node to the first and second switching node respectively, the first and second switching node are effectively separated from each other. In the same way, by using a separate third and fourth resistor to couple the second input node to the third and fourth switching nodes respectively, the third and fourth switching node are effectively separated from each other.

In another preferred embodiment the switching means comprises: a first switch for coupling the first switching node to the first output node during the second phase of the oscillator signal; a second switch for coupling the second switching node to the second output node during the first phase of the oscillator signal; a third switch for coupling the third switching node to the first output node during the first phase of the oscillator signal; and a fourth switch for coupling the fourth switching node to the second output node during the second phase of the oscillator signal. This is a simple and effective way of mixing the input signal received at the first and second input nodes.

Yet another preferred embodiment comprises a third input node and a fourth input node for receiving a second input signal, and a second voltage-to-current conversion means comprising a third voltage-to-current converter for generating a fifth current at the first output node and a sixth current at the second output node in response to the second input signal. Preferably the third voltage-to-current converter comprises a fifth resistor coupled between the third input node and the first output node and a sixth resistor coupled between the fourth input node and the second output node. In this embodiment a second input signal is added to the mixed input signal. Such a mixer can advantageously be applied in a so-called intermediate frequency-to-digital converter or IF-to-digital converter which converts a intermediate frequency signal, as for instance present in a receiver, to a digital base-band signal. Such an IF-to-digital converter may by implemented by means of a sigma-delta modulator having a negative feedback path comprising a digital-to-analog converter (DAC). The second input signal may for instance be a feedback signal generated by the DAC.

Yet another preferred embodiment comprises a current-to-voltage converter for generating an output signal at a third output node and a fourth output node in response to currents applied at the first output node and the second output node. In this embodiment the output signal of the mixer circuit is in the voltage domain. This simplifies interfacing the mixer circuit with other circuits.

In yet another preferred embodiment the current-to-voltage converter is an integrating current-to-voltage converter. In IF-to-digital converters based on a sigma-delta modulator an integrator is usually cascaded with the mixer circuit. By using an integrating current-to-voltage converter the integrator is integrated in the mixer circuit thereby simplifying the design of the IF-to-digital converter.

Yet another preferred embodiment comprises second switching means arranged to couple: the first switching node and the fourth switching node to a reference node during the first phase of the oscillator signal, and the second switching node and the third switching node to the reference node during the second phase of the oscillator signal. The first and fourth switching nodes are floating at least during a part of the first phase of the oscillator signal, while the second and third switching nodes are floating during at least a part of the second phase of the oscillator signal. By connecting the floating switching nodes to a reference voltage the associated parasitic capacitances are discharged. This further decreases the distortion introduced by the mixer circuit.

The above and other objects and features of the present invention will become more apparent from the following detailed description considered in connection with the accompanying drawings in which:

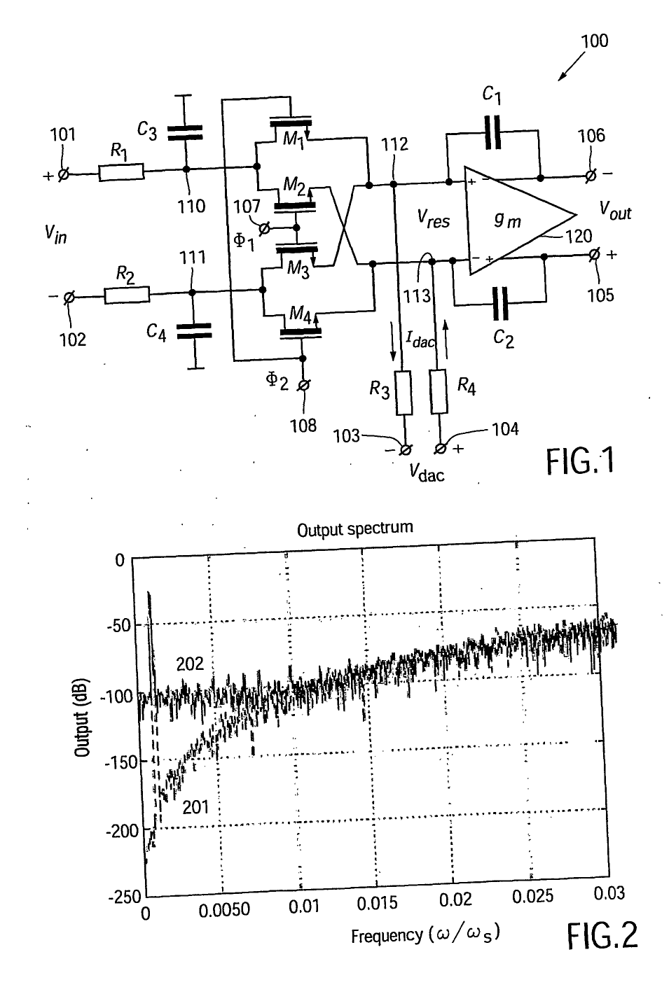

FIG. 1 shows a schematic diagram of a conventional mixer circuit;

FIG. 2 shows graphs with simulated output spectra of IF-to-digital converters;

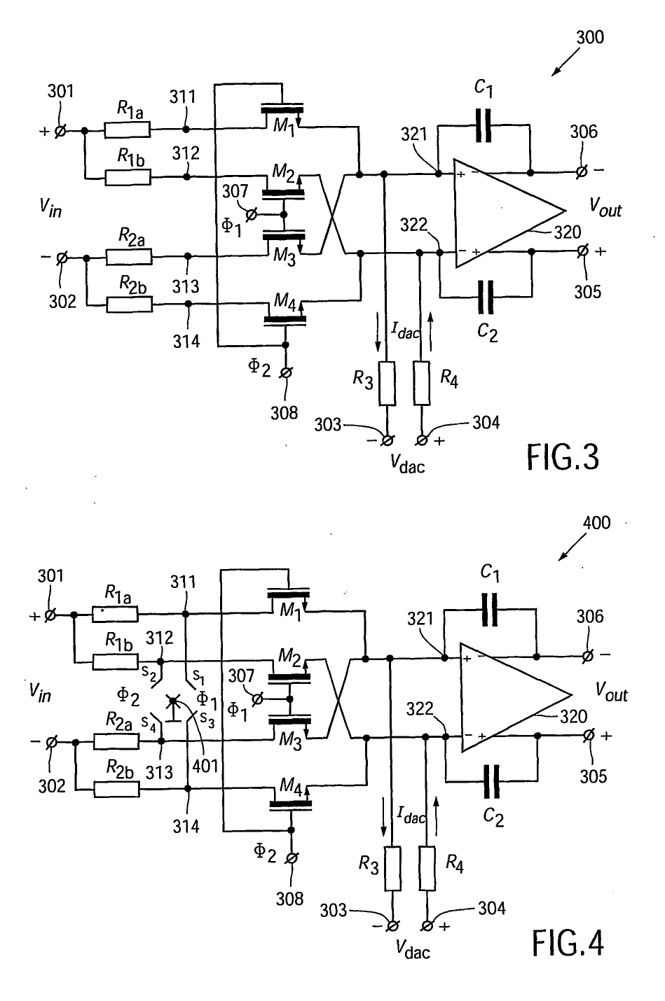

FIG. 3 shows a schematic diagram of an embodiment of a mixer circuit according to the invention;

FIG. 4 shows a schematic diagram of another embodiment of a mixer circuit according to the invention;

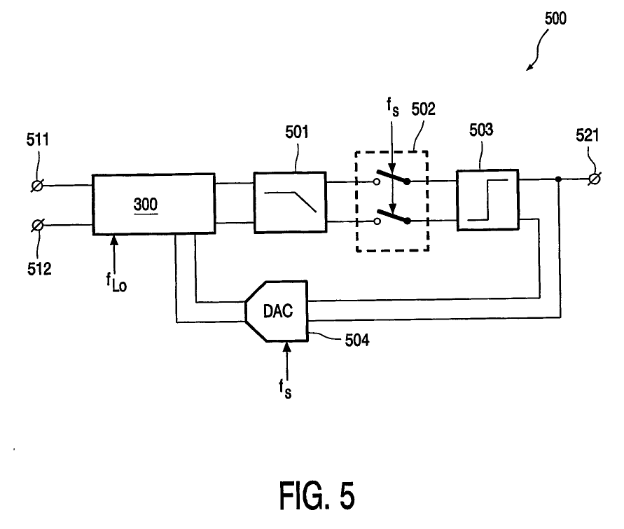

FIG. 5 shows a functional block diagram of an IF-to-digital converter comprising a mixer circuit according to the invention; and

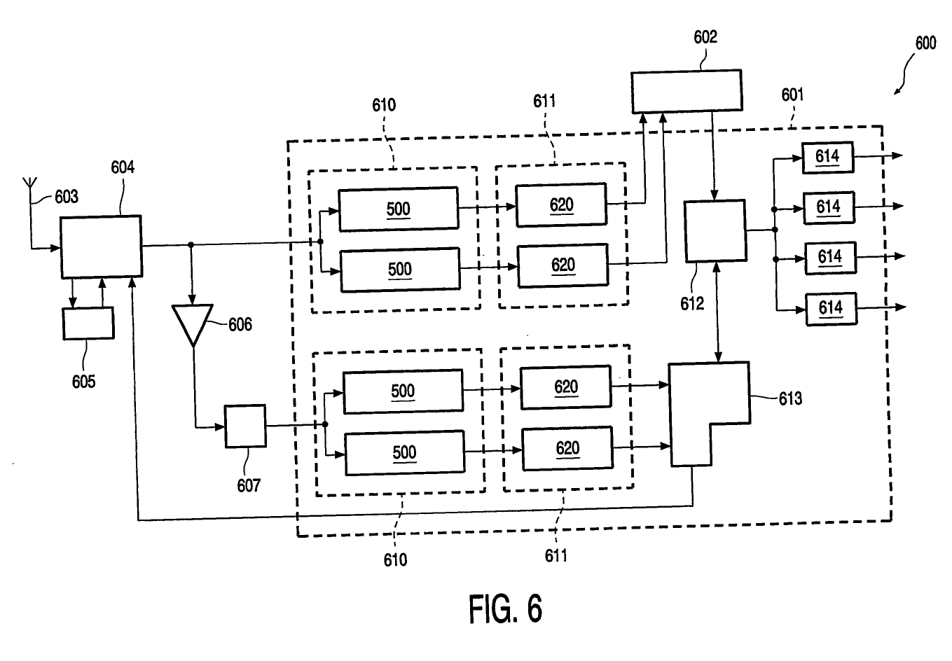

FIG. 6 shows a functional block diagram of a receiver comprising an IF-to-digital converter according to the invention.

In these figures identical parts are identified with identical references.

FIG. 1 shows a schematic diagram of a conventional mixer circuit 100. The shown mixer circuit 100 has a first voltage-to-current converter comprising resistors R1 and R2 for converting a first differential input signal Vin into a first differential input current, a mixer stage comprising N-MOSFETs M1, M2, M3, and M4 for mixing the first differential input current under control of an oscillator signal having a first and a second non-overlapping phase φ1 and φ2 respectively, a second voltage-to-current converter comprising resistors R3 and R4 for converting a second differential input voltage Vdac into a second differential input current Idac, and an integrating current-to-voltage converter comprising operational transconductance amplifier (OTA) 120, and capacitors C1 and C2, for integrating the difference of the mixed first differential input current and the second differential input current, and converting it into a differential output voltage Vout.

In the first voltage-to-current converter resistor RI connects a first input node 101 with a first switching node 110. Resistor R2 connects a second input node 102 with a second switching node 111. Resistors R1 and R2 are identical or at least substantially identical to each other.

In the mixer stage the drain of N-MOSFET M1 is connected to the first switching node 110, its source to a first output node 112 of the mixer stage, while the second phase φ2 of the oscillator signal is applied to its gate. The drain of N-MOSFET M2 is connected to the first switching node 110, its source to a second output node 113 of the mixer stage, while the first phase φ1 of the oscillator signal is applied to its gate. The drain of the third N-MOSFET M3 is connected to the second switching node 111, its source to the first output node 112 of the mixer stage, while the first phase φ1 of the oscillator signal is applied to its gate. The drain of the fourth mixer N-MOSFET M4 is connected to the second switching node 111, its source to the second output node 113 of the mixer stage, while the second phase φ2 of the oscillator signal is applied to its gate. The N-MOSFETs M1, M2, M3, and M4 are identical or at least substantially identical to each other. During the first phase φ1 of the oscillator signal N-MOSFETs M2 and M3 are conductive, while during the second phase φ2 of the oscillator signal N-MOSFETs M1 and M4 are conductive, thus forming a passive MOS mixer.

In the second voltage-to-current converter resistor R3 connects a third input node 103 with the first output node 112 of the mixer stage. Resistor R4 connects a fourth input node 104 with the second output node 113 of the mixer stage. Resistors R3 and R4 are identical or at least substantially identical to each other.

In the integrating current-to-voltage converter a non-inverting input of the operational transconductance amplifier 120 is connected to the first output node 112 of the mixer stage and an inverting input of the operational transconductance amplifier 120 is connected to the second output node 113 of the mixer stage. The non-inverting output of the operational transconductance amplifier 120 is connected to a first output node 105 and an inverting output of the operational transconductance amplifier 120 is connected to a second output node 106. Capacitor C1 is connected between the first output node 112 of the mixer stage and the first output node 105. Capacitor C2 is connected between the second output node 113 of the mixer stage and the second output node 106. The integrating capacitors C1 and C2 form a negative feedback loop. Due to the high gain of the OTA 120 the first and second output nodes 112, 113 which are also the input nodes of the OTA are virtual ground nodes.

The mixer circuit 100 is typically used in an IF-to-digital sigma-delta converter in which the first input signal Vin is an IF-signal that is converted to a base-band signal in the mixer stage, while the second input signal is a negative feedback signal generated by a digital-to-analog converter (DAC) in the feedback path of the converter. Thus effectively the output signal of the DAC is subtracted from the base-band output signal of the mixer stage at the virtual ground nodes 112, 113 of the OTA 120. The resulting error signal is integrated into the output voltage Vout. A similar IF-to-digital converter comprising a mixer circuit according to the invention is shown in FIG. 5 and will be discussed in detail in the accompanying description.

A problem associated with mixer circuit 100 is its high sensitivity to interference at the first and second switching nodes 110 and 111, due to the finite gain of the OTA 120 and parasitic capacitance C3, present between the first switching node 110 and ground, and parasitic capacitance C4, present between the second node 111 and ground. Because of the finite gain of the OTA 120 a differential residue voltage Vres is present between the virtual ground nodes 112 and 113. The residue voltage Vres can be approximated by

$$Vres = \frac{1}{gm} \cdot ( \frac{Vin}{Rin} + \frac{Vdac}{Rdac} ) - \frac{{( gm )}^{3}}{32 \cdot {( gm )}^{4} \cdot {( Ib )}^{2}} \cdot {( \frac{Vin}{Rin} + \frac{Vdac}{Rdac} )}^{3} + …$$

Herein Rin equals the input resistance R1 (=R2), Rdac equals the feedback resistance R3 (=R4), Ib is the bias current and gm the transconductance factor of the OTA 120. In the following analysis it is assumed that Vin is zero and the feedback voltage Vdac is a constant offset voltage. Assuming the oscillator φ1 is low (VSS) and f2 is high (VDD), the residue voltage Vres is sampled at parasitic capacitances C3 and C4 by means of switches M1 and M4 respectively, which are closed, while switches M2 and M3 are open. In the complementary oscillator phase, signal φ1 is high, while signal φ2 is low. Thus switches M2 and M3 are closed and switches M1 and M4 are open. During this phase the sampled residue voltage at the first and second switching nodes 110, 111 is cross-coupled to the input nodes 112, 113 of the OTA 120, having an opposite sign of the residue voltage at first and second switching nodes 110, 111. The voltages at first and second switching nodes 110, 111 and input nodes 112, 113 of the OTA 120 are equalized by a charge transfer from parasitic capacitances C3 and C4 to the integration capacitors C1 and C2 through switches M2 and M3. Thus the parasitic capacitances C3 and C4 result in parasitic mixing of the DAC voltage Vdac.

A sigma-delta modulator having mixer circuit 100 as an input stage is particularly sensitive to this form of parasitic mixing, as the feedback signal from the DAC contains a large portion of out-of-band noise. This will be discussed more in detail in connection with FIG. 2.

Another disadvantage of mixer circuit 100 is that phases φ1 and φ2 of the oscillator signal need to be non-overlapping to prevent switches M1, M2, M3, and M4 from conducting all at the same time, which would result in unwanted short circuits, because M1 and M2 have a common input, switching node 110, and because M3 and M4 also have a common input, switching node 111. The fact phases φ1 and φ2 are non-overlapping results in a mixed input signal that is slightly unbalanced. As a result parasitic mixing also occurs at even harmonics of the oscillator signal.

FIG. 2 shows graphs with simulated output spectra of IF-to-digital converters. The vertical axis shows the output power in dB, while the horizontal axis shows the frequency ω normalized to the sampling frequency ωs. The graphs show the influence of parasitic mixing as discussed in connection with FIG. 1. Graph 201 shows the output power spectrum of an ideal noise-shaping IF-to-digital converter having a signal component at ωs/1000. The quantization noise is very low at the base-band and rises with the order of the loop-filter. Graph 202 shows the output spectrum of a noise-shaping IF-to-digital converter comprising the mixer circuit 100 shown in FIG. 1, having parasitic mixing at half the sampling frequency ωs. The quantization noise is substantially higher than in case of the ideal noise-shaping IF-to-digital converter. A fraction of this noise power is mixed down into the base-band. As a consequence the resolution in the signal band at ωs/1000 is seriously affected.

FIG. 3 shows a schematic diagram of an embodiment of a mixer circuit according to the invention 300. The mixer circuit 300 according to the invention has a first voltage-to-current converter comprising resistors R1a and R2a for converting a first differential input signal Vin into a first differential current, a second voltage-to-current converter comprising resistors R1b and R2b for converting the first differential input signal Vin into a second differential current, a mixer stage comprising N-MOSFETs M1, M2, M3, and M4 for generating in mixed differential current in dependence upon the first differential current and the second differential current under control of an oscillator signal having a first phase φ1 and a second phase φ2, a third voltage-to-current converter comprising resistors R3 and R4 for converting a second differential input voltage Vdac into a third differential current Idac, and an integrating current-to-voltage converter comprising operational transconductance amplifier (OTA) 320, and integrating capacitors C1 and C2, for integrating the difference of the mixed differential current and the third differential current, and converting it into a differential output voltage Vout.

In the first voltage-to-current converter resistor R1a connects a first input node 301 with a first switching node 311. Resistor R2a connects a second input node 302 with a third switching node 313.

In the second voltage-to-current converter resistor R1b connects a first input node 301 with a second switching node 312. Resistor R2b connects a second input node 302 with a fourth switching node 314. The resistors R1a, R2a, R1b, and R2b are identical or at least substantially identical to each other.

In the mixer stage the drain of N-MOSFET M1 is connected to the first switching node 311, its source to a first output node 321 of the mixer stage, while the second phase φ2 of the oscillator signal is applied to its gate. The drain of N-MOSFET M2 is connected to the second switching node 312, its source to a second output node 322 of the mixer stage, while the first phase φ1 of the oscillator signal is applied to its gate. The drain of the third N-MOSFET M3 is connected to the third switching node 313, its source to the first output node 321 of the mixer stage, while the first phase φ1 of the oscillator signal is applied to its gate. The drain of the fourth mixer N-MOSFET M4 is connected to the fourth switching node 314, its source to the second output node 322 of the mixer stage, while the second phase φ2 of the oscillator signal is applied to its gate. The N-MOSFETs M1, M2, M3, and M4 are identical or at least substantially identical to each other. During the first phase φ1 of the, oscillator signal N-MOSFETs M2 and M3 are conductive, while during the second phase φ2 of the oscillator signal N-MOSFETs M1 and M4 are conductive, thus forming a passive MOS mixer.

In the third voltage-to-current converter resistor R3 connects a third input node 303 with the first output node 321 of the mixer stage. Resistor R4 connects a fourth input node 304 with the second output node 322 of the mixer stage. Resistors R3 and R4 are identical or at least substantially identical to each other.

In the integrating current-to-voltage converter a non-inverting input of the operational transconductance amplifier 320 is connected to the first output node 321 of the mixer stage and an inverting input of the operational transconductance amplifier 320 is connected to the second output node 322 of the mixer stage. The non-inverting output of the operational transconductance amplifier 320 is connected to a first output node 305 and an inverting output of the operational transconductance amplifier 320 is connected to a second output node 306. Capacitor C1 is connected between the first output node 321 of the mixer stage and the first output node 305. Capacitor C2 is connected between the second output node 322 of the mixer stage and the second output node 306. The integrating capacitors C1 and C2 form a negative feedback loop. Due to the high gain of the OTA 320 the first and second output nodes 321, 322 which are also the input nodes of the OTA are virtual ground nodes.

As with the prior art mixer circuit 100, discussed in connection with FIG. 1, the mixer circuit 300 according to the invention is typically used in an IF-to-digital sigma-delta converter in which the first input signal Vin is an IF-signal that is converted to a base-band signal in the mixer stage, while the second input signal Vdac is a negative feedback signal generated by a digital-to-analog converter (DAC) in the feedback path of the converter. Thus effectively the output signal of the DAC is subtracted from the base-band output signal of the mixer stage at the virtual ground nodes 321, 322 of the OTA 320. The resulting error signal is integrated and converted into the output voltage Vout. An IF-to-digital converter comprising the mixer circuit 300 according to the invention is shown in FIG. 5 and will be discussed in detail in the accompanying description.

By using a first voltage-to-current converter comprising resistors R1a and R2a, and a separate second voltage-to-current converter comprising resistors R1b and R2b, the input nodes 311 and 312 of switches M1 and M2 respectively, as well as the input nodes 313 and 314 of switches M3 and M4 respectively are isolated from each other by resistors R1a and R1b, and R2a and R2b respectively. Thus a parasitic capacitance associated with switching node 311 cannot directly be discharged through switch M2, since it has to go through resistors R1a and R1b that are preferably high ohmic compared to the on-resistance of the switch M2. Hereby switching nodes 311 and 313 are isolated from node 322, and switching nodes 312 and 314 are isolated from node 321. As a result the effect of parasitic mixing is suppressed with a factor G

$$G ∝ \frac{Ron}{Rin}$$

Herein Ron is the on-resistance of the switches M1, M2, M3, or M4, and Rin is the input resistance of the first and second voltage-to-current converter, and thus equals R1a (=R1b=R2a=R2b). Preferably G<<1.

A further advantage of mixer circuit 300 is that the phase φ1 and φ2 not need to be non-overlapping, because the input nodes 321 and 322 of the OTA 320 are not short-circuited in case switches M1, M2, M3, and M4 are conductive simultaneously. Therefore a more symmetrical oscillator signal can be applied to the mixer circuit 300 resulting in an improved canceling of the second harmonics of the oscillator signal.

FIG. 4 shows a schematic diagram of another embodiment of a mixer circuit 400 according to the invention. The mixer circuit 400 according to the invention has a first voltage-to-current converter comprising resistors R1a and R2a for converting a first differential input signal Vin into a first differential current, a second voltage-to-current converter comprising resistors R1b and R2b for converting the first differential input signal Vin into a second differential current, a mixer stage comprising N-MOSFETs M1, M2, M3, and M4 for generating in mixed differential current in dependence upon the first differential current and the second differential current under control of an oscillator signal having a first phase φ1 and a second phase φ2, a third voltage-to-current converter comprising resistors R3 and R4 for converting a second differential input voltage Vdac into a third differential current, and an integrating current-to-voltage converter comprising operational transconductance amplifier (OTA) 320, and integrating capacitors C1 and C2, for integrating the difference of the mixed differential current and the third differential current, and converting it into a differential output voltage Vout. The first, second, and third voltage to current converter, the mixer stage, and the integrating current-to-voltage converter are identical to the respective counterparts in mixer circuit 300 shown in FIG. 3, and are connected to each other in an identical way. For this reason they will not be discussed here in detail.

Mixer circuit 400 differs from mixer circuit 300 shown in FIG. 3 by the presence of switches S1, S2, S3, and S4. Switch S1 is connected between switching node 311 and a reference node 401. It is conductive during phase φ1 of the oscillator signal. Switch S2 is connected between switching node 312 and the reference node 401. It is conductive during phase φ2 of the oscillator signal. Switch S3 is connected between switching node 313 and the reference node 401. It is conductive during phase φ1 of the oscillator signal. Switch S4 is connected between switching node 314 and the reference node 401. It is conductive during phase φ2 of the oscillator signal.

The pair of switches M2 and M3 is driven with phase φ1 of the oscillator signal, while the pair of switches M1 and M4 is driven with phase φ2 of the oscillator signal. Thus during phase φ1 switching nodes 311 and 314 are effectively floating and during phase φ2 switching nodes 312 and 313 are effectively floating. By closing switches S1 and S3 during phase φ1, parasitic capacitances associated with switching nodes 311 and 314 are discharged. By closing switches S2 and S4 during phase φ2, parasitic capacitances associated with switching nodes 312 and 313 are discharged. This further decreases the parasitic mixing in the mixer circuit 400.

FIG. 5 shows a functional block diagram of an IF-to-digital converter 500 comprising a mixer circuit 300 according to the invention. A differential IF signal is applied at the input nodes 511 and 512 of the IF-to-digital converter, while a one bit digital output signal is generated at the output node 521. Under control of a two phase local oscillator signal with frequency fLO the IF input signal is mixed in mixer circuit 300. An error signal resulting from the subtracting a feedback signal generated by digital-to-analog converter (DAC) 504 operating at a sample frequency fs from the mixed input signal, is integrated in mixer circuit 300. The integrated error signal is filtered in a low-pass filter 501 and sampled at sample frequency fs in sampler 502. By means of the comparator 503 the sampled filtered integrated error signal is digitized into the one bit digital output signal. Also the output signal of the comparator forms the input signal of DAC 504.

In a practical application IF-to-digital converter 500 is used both in the I and Q signal path of a receiver. The IF input signal is mixed down to the base-band by the mixer circuit 300 operating at the local oscillator frequency fLO. In practice the sample frequency is chosen such that it is a multiple of the local oscillator frequency, for instance two or four times. In that way the for the base-band signals the full converter bandwidth can be used.

FIG. 6 shows a functional block diagram of a receiver 600 comprising an IF-to-digital converter 500 according to the invention. The receiver is capable of handling AM, FM, and digital radio signals conforming the IBOC (In Band On Channel) standard. Based on the quality of the received signal the receiver decides to process the received radio signals in either an analog AM/FM mode or in an IBOC mode. It comprises a tuner 604 that tuner comprises a ceramic filter 605 for filtering out IBOC signal bands when the IBOC mode is active. Furthermore the receiver comprises two IF-to-digital converter modules 610, each having two IF-to-digital converters 500 according to the invention for processing the I (in-phase) and Q (quadrature-phase) signal paths respectively. The first of the two IF-to-digital converter modules 610 is arranged for processing signals in the IBOC mode and receives its input signal directly from the receiver. The second IF-to-digital converter module 500 is arranged for processing signals in the AM/FM mode and receives its input signal from the receiver via an amplifier 606 and a ceramic AM/FM filter 607. Furthermore the receiver comprises two IF post processing modules, a first for processing digitized signals in the IBOC mode, a second for processing digitized signals in the AM/FM mode. Each IF post-processing module 611 has two IF post-processors 620 for processing the digitized signals on the respective I and Q signal paths. In the IBOC mode the post processed digitized I and Q signals are demodulated in an IBOC processor 602 that outputs the demodulated signal to an audio processor 612, which further processes the signal and outputs the resulting audio signals via digital-to-analog converters 614. In the AM/FM mode the post-processed digitized I and Q signals are demodulated in a radio DSP (digital signal processor) 613 that outputs the demodulated signal to the audio processor 612, which further processes the signal and outputs the resulting audio signals via the digital-to-analog converters 614. Preferably the IF-to-digital converter modules 500, IF post-processing modules, the radio DSP 613, the audio processor 612, and the DACs 614 are integrated as a single integrated circuit 601.

In measurements it appeared that the IF-to-digital converter module 610, realized in a 018 μm CMOS process, is capable of achieving a dynamic range of 99 dB in a 3 kHz AM bandwidth, 79 dB in the 200 kHz FM band, and 74 dB in the 575 kHz band for IBOC.

The IBOC signals are digital COFDM modulated side-bands around the conventional AM/FM channels. In the receiver 600 the quality of the received radio signal is checked continuously and depending on the quality it switches automatically between the analog AM/FM mode and the digital IBOC mode.

In the receiver 600 the IF-to-digital converters 500 each comprise a 5^{th} order base-band sigma-delta modulator. The IF-to-digital converter modules 610 convert a 10.7 MHz analog input channel to a base-band output at 300 kHz. The IF post-processing modules 611 take care of down sampling, filtering, and frequency translation of the 300 kHz base-band signal to DC. The output bit-stream of a IF-to-digital converter 500 is down sampled by a factor of 128 for AM/FM signals and by a factor of 64 for IBOC signals. The 22 bit I and Q output words at a 325 ksample/sec rate for AM/FM radio are further processed by the software on the radio DSP 613. The 16 bit I and Q words at a 650 ksample/sec rate for IBOC are transferred in a serial mode to the IBOC processor 602.

Software running on the processors 602 and 613 handles the demodulation of the respective I and Q signals. Furthermore it may fulfill other radio functions such as for instance signal quality improvement, level tracking, stereo demodulation, weak signal handling, RDS demodulation, and multi-path suppression. Multiple AGC (automatic gain control) loops, not shown in FIG. 6, assure that the full dynamic range of the IF-to-digital converters 500 is used for all antenna levels. After radio signal processing in the processors 602 and 603, digital audio formatted data is delivered to the audio processor 612 where further audio processing is done. Hereafter the digital audio signals are converted to analog audio signals by means of the DACs 614.

In receiver 600 a radio frequency signal is received at antenna 603.

The shown receiver 600 is for use in a for instance a car radio system. It is arranged to receive.

The embodiments of the present invention described herein are intended to be taken in an illustrative and not a limiting sense. Various modifications may be made to these embodiments by those skilled in the art without departing from the scope of the present invention as defined in the appended claims.

In the embodiments of the invention discussed in connection with FIG. 1, FIG. 3, and FIG. 4 N-MOSFETs are used for switches M1, M2, M3, and M4. It will be clear to those skilled in the art that instead of N-MOSFETs or types of switches may be used, for instance P-MOSFETs or transmission gates.

The embodiments of the invention discussed in connection with FIG. 1, FIG. 3, and FIG. 4 relate to mixer circuits in which the first voltage-to-current converter and the second voltage-to-current converter are realized by means of resistors. Other types of voltage-to-current converters, for instance active voltage-to-current converters, having the same effect of isolating the switching nodes from each other, may be used instead of the resistors. Furthermore other types of current-to-voltage converters may be used.

The embodiments of the invention discussed in connection with FIG. 1, FIG. 3, and FIG. 4 relate to mixer circuits in which a second input signal is subtracted from a mixed first input signal. It will be clear to those skilled in the art that with a simple readjustment of the connections at the input nodes of the integrating current-to-voltage converter the second input signal can be added to the mixed first input signal.

1. A mixer circuit (300) comprising a first input node (301) and a second input node (302) for receiving an input signal (Vin), a first output node (321) and a second output node (322), voltage-to-current conversion means (R1a, R1b, R2a, R2b), and switching means (M1, M2, M3, M4) operatively coupled to each other and to the first input node (301), the second input node (302), the first output node (321), and the second output node (322) to generate a mixed input signal at the first output node (321) and the second output node (322) in response to an oscillator signal, characterized in that
the voltage-to-current conversion means (R1a, R1b, R2a, R2b) comprises:
a first voltage-to-current converter (R1a, R2a) for generating a first current at a first switching node (311) and a third current at a third switching node (313) in response to the input signal (Vin), and
a second voltage-to-current converter (R1b, R2b) for generating a second current at a second switching node (312) and a fourth current a fourth switching node (314) in response to the input signal (Vin); and
the switching means (M1, M2, M3, M4) is arranged to couple:
the second switching node (312) to the second output node (322) and the third switching node (313) to the first output node (321) during a first phase (φ1) of the oscillator signal; and
the first switching node (311) to the first output node (321) and the fourth switching node (314) to the second output node (322) during a second phase (φ2) of the oscillator signal.

2. A mixer circuit as claimed in claim 1, characterized in that
the first voltage-to-current converter (R1a, R2a) comprises a first resistor (R1a) coupled between the first input node (301) and the first switching node (311) and a third resistor (R2a) coupled between the second input node (302) and the third switching node (313); and
the second voltage-to-current converter (R1b, R2b) comprises a second resistor (R1b) coupled between the first input node (301) and the second switching node (312) and a fourth resistor (R2b) coupled between the second input node (302) and the fourth switching node (314).

3. A mixer circuit as claimed in claim 1, characterized in that the switching means (M1, M2, M3, M4) comprises:
a first switch (M1) for coupling the first switching node (311) to the first output node (321) during the second phase (φ2) of the oscillator signal;
a second switch (M2) for coupling the second switching node (312) to the second output node (322) during the first phase (φ1) of the oscillator signal;
a third switch (M3) for coupling the third switching node (313) to the first output node (321) during the first phase (φ1) of the oscillator signal; and
a fourth switch (M4) for coupling the fourth switching node (314) to the second output node (322) during the second phase (φ2) of the oscillator signal.

4. A mixer circuit as claimed in claim 1, characterized in that it comprises a third input node (303) and a fourth input node (304) for receiving a second input signal (Vdac), and a second voltage-to-current conversion means (R3, R4) comprising a third voltage-to-current converter (R3, R4) for generating a fifth current at the first output node (321) and a sixth current at the second output node (322) in response to the second input signal (Vdac).

5. A mixer circuit as claimed in claim 4, characterized in that the third voltage-to-current converter comprises a fifth resistor (R3) coupled between the third input node (303) and the first output node (321) and a sixth resistor (R4) coupled between the fourth input node (304) and the second output node (322).

6. A mixer circuit as claimed in claim 1, characterized in that it comprises a current-to-voltage converter (320, C1, C2) for generating an output signal (Vout) at a third output node (305) and a fourth output node (306) in response to currents applied at the first output node (321) and the second output node (322).

7. A mixer circuit as claimed in claim 7, characterized in that the current-to-voltage converter (320, C1, C2) is an integrating current-to-voltage converter.

8. A mixer circuit as claimed in claim 1, characterized in that it comprises second switching means (S1, S2, S3, S4) arranged to couple:
the first switching node (311) and the fourth switching node (314) to a reference node (401) during the first phase (φ1) of the oscillator signal, and
the second switching node (312) and the third switching node (313) to the reference node (401) during the second phase (φ2) of the oscillator signal.

9. A receiver for receiving radio frequency signals comprises an antenna section coupled to a receiver section, having a local oscillator for generating an oscillator frequency, being arranged to output a signal at a lower frequency, characterized in that the receiver section comprises a mixer circuit as claimed in claim 1 for mixing the oscillator signal with the radio frequency signals.

10. A method for generating an output signal by mixing an input signal (Vin) with an oscillator signal having a first phase (φ1) and a second phase (φ2), whereby the output signal comprises a first output current and a second output current, in a mixer circuit (300) comprising a first input node (301) and a second input node (302) for receiving the input signal (Vin), a first output node (321) for providing the first output current and a second output node (322) for providing the second output current, voltage-to-current conversion means (R1a, R1b, R2a, R2b), and switching means (M1, M2, M3, M4) operatively coupled to each other and to the first input node (301), the second input node (302), the first output node (321), and the second output node (322) to generate the output signal at the first output node (321) and the second output node (322) in response to the oscillator signal, characterized in that
the voltage-to-current conversion means (R1a, R1b, R2a, R2b) comprises
a first voltage-to-current converter (R1a, R2a) for generating a first current at a first switching node (311) and a third current at a third switching node (313) in response to the input signal (Vin), and
a second voltage-to-current converter (R1b, R2b) for generating a second current at a second switching node (312) and a fourth current a fourth switching node (314) in response to the input signal (Vin); and
the switching means (M1, M2, M3, M4) is arranged to couple:
the second switching node (312) to the second output node (322) and the third switching node (313) to the first output node (321) during the first phase (φ1) of the oscillator signal; and
the first switching node (311) to the first output node (321) and the fourth switching node (314) to the second output node (322) during the second phase (φ2) of the oscillator signal.
